(19) United States
(12) Patent Application Publication
(10) Pub. No.: US 2013/0154312 A1
(43) Pub. Date: Jun. 20, 2013

(54) SLIDING STRUCTURE OF PANORAMA SUN ROOF FOR VEHICLE

(71) Applicants: Dong Hoon Lee, Hwaseong-si (KR); Hwa Kyong Sung, Hwaseong-si (KR)

(72) Inventors: Dong Hoon Lee, Hwaseong-si (KR); Hwa Kyong Sung, Hwaseong-si (KR)

(73) Assignees: Inalfa Roof Systems Korea Ltd., Hwaseong-si (KR); Hyundai Motor Company, Seoul (KR)

(21) Appl. No.: 13/608,376

(22) Filed: Sep. 10, 2012

(30) Foreign Application Priority Data
Dec. 15, 2011 (KR) 10-2011-00135798

(51) Int. Cl. B60J 7/047

(52) U.S. Cl. 296/216.04

(57) ABSTRACT

A sliding structure of a panorama sun roof for a vehicle, wherein a roof panel of the vehicle may be mounted with the panorama sun roof, may include a guide rail mounted to the panorama sun roof, wherein an end of the guide rail may be molded with an elastic member, and a guide member mounted in the guide rail for the panorama sun roof to slidably move along the guide rail of the roof panel.

### CROSS-REFERENCE TO RELATED APPLICATION

The present application claims priority to Korean Patent Application No. 10-2011-0135798, filed on Dec. 15, 2011, the entire contents of which is incorporated herein for all purposes by this reference.

### BACKGROUND OF THE INVENTION

1. Field of the invention

The present invention relates to a sliding structure of a panorama sun roof for a vehicle, and more particularly, to a sliding structure of a panorama sun roof for a vehicle for preventing noise and vibrations from occurring at the time of closing a panorama sun roof mounted in a vehicle.

2. Description of Related Art

Generally, a roof panel of a vehicle is mounted with a sun roof capable of being partially opened and completely opened.

The sun roof is manufactured to circulate air in a vehicle and give unobstructed openness. Recently, the sun roof is subjected to heat treatment to withstand strong sunlight and may be made of a glass material for effectively blocking ultraviolet rays and infrared rays. Further, the sun roof is made of a high strength material so as to prevent passengers from being injured by fragments of glass at the time of the accident.

Generally, the sun roof may be considered as a window frame at which the roof panel is opened. Recently, the sun roof is formed so that only an upper portion thereof can be slightly lifted up to circulate air in the state in which the roof panel is not opened.

In addition, recently, a panorama sun roof providing feelings of a convertible car by making most of the roof panel in addition to the front portion of a vehicle of glass so as to maximize openness becomes popular.

The panorama sun roof may be classified into a two-piece type and a three-piece type according to the number of glasses used and the glass thereof is operated to be opened in a tilt or sliding manner according to a mechanism structure.

FIG. 1 is a diagram showing a panorama sun roof for a vehicle according to the related art and FIG. 2 is a diagram showing a guide rail of a panorama sun roof for a vehicle according to the related art.

Describing the sliding structure of the panorama sun roof for a vehicle according to the related art, a roof panel 10 of a vehicle mounted with a panorama sun roof 20 is mounted with a guide rail 11 and is mounted with a guide member 21 for the panorama sun roof 20 to slidably move along the guide rail 11 of the roof panel 10.

However, the sliding structure of the panorama sun roof for a vehicle according to the related art does not include a separate damping member, which may lead to vibrations and noise when the guide member 21 is combined with an end of the guide rail 11 so as to close the panorama sun roof 20.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a sliding structure of a panorama sun roof for a vehicle, and in particular, to prevent noise and vibrations from occurring at the time of closing a panorama sun roof mounted in a vehicle.

In one aspect of the present invention, a sliding structure of a panorama sun roof for a vehicle, wherein a roof panel of the vehicle is mounted with the panorama sun roof, may include a guide rail mounted to the panorama sun roof, wherein an end of the guide rail is molded with an elastic member, and a guide member mounted in the guide rail for the panorama sun roof to slidably move along the guide rail of the roof panel.

The elastic member is a leaf spring.

The leaf spring is shaped of “ [symbol] ”.

A side portion of the end of the guide rail molded in the leaf spring is mounted with a guide hole.

A lower portion of the end of the guide rail is mounted with an auxiliary guide rail and one side of the auxiliary guide rail is mounted with an auxiliary guide hole.

The auxiliary guide hole is positioned between the auxiliary guide rail and the guide rail.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram showing a panorama sun roof structure for a vehicle.

FIG. 2 is a diagram showing a guide rail of the panorama sun roof for a vehicle according to the related art.

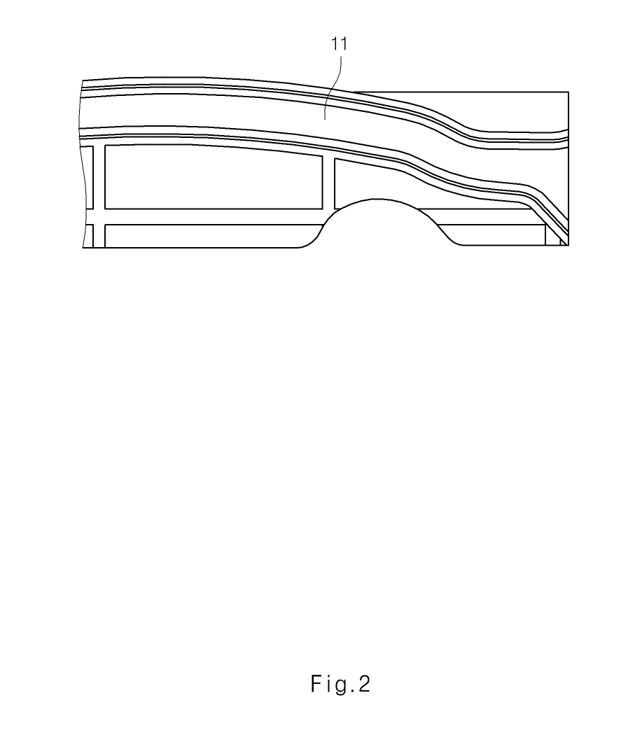

FIG. 3 is a diagram showing a sliding structure of a panorama sun roof for a vehicle according to an exemplary embodiment of the present invention.

FIG. 4 is a diagram showing a sliding structure of a panorama sun roof for a vehicle according to the leaf spring of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

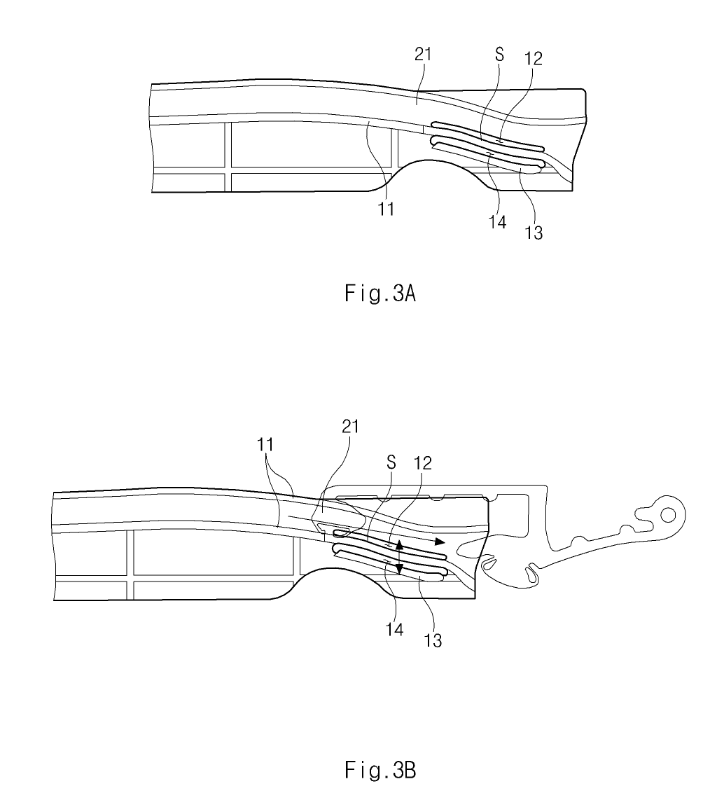

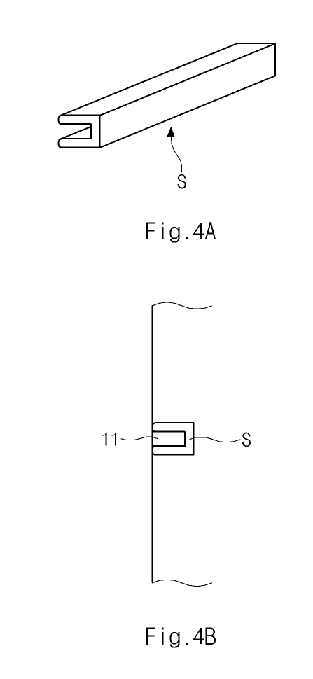

FIGS. 3 and 4 is a diagram showing a sliding structure of a panorama sun roof for a vehicle according to an exemplary embodiment of the present invention.

Exemplary embodiments of the present invention will be described in detail with reference to the accompanying drawings.

As shown in FIGS. 3 and 4, a sliding structure of a panorama sun roof for a vehicle according to the exemplary embodiment of the present invention is made by molding an end of a guide rail 11 of a roof panel 10 for a vehicle in a leaf spring S to prevent noise and vibrations from occurring when a guide member 21 of the panorama sun roof 20 sled along the guide rail 11 move to the end of the guide rail 11.

Hereinafter, each component of the sliding structure of a panorama sun roof for a vehicle will be described with reference to the accompanying drawings.

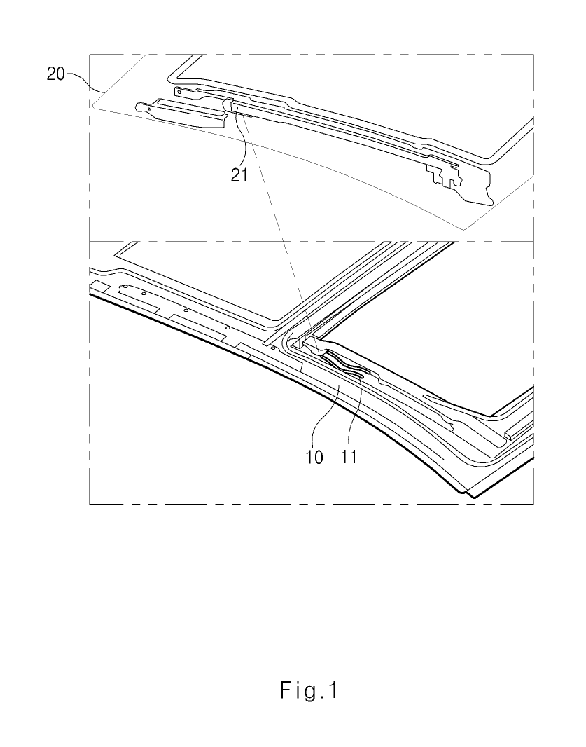

First, according to the exemplary embodiment of the present invention, as shown in FIGS. 1 and 3, the roof panel 10 for a vehicle mounted with the panorama sun roof 20 is mounted with the guide rail 11 and is mounted with the guide member 21 of the panorama sun roof 20 slidably moving along the guide rail 11 of the roof panel 10. In this case, the end of the guide rail 11 is molded in a leaf spring S.

In this configuration, the leaf spring S is made of a material having elasticity and is molded at the end of the guide rail 11, which makes it easy to slidably move the guide member 21 along the guide rail 11 at the time of operating the panorama sun roof 20.

In this case, the reason why the guide member 21 can be easily sled along the guide rail 11 is that the end of the guide rail 11 is molded in the leaf spring S having elasticity to vertically expand and contract the end of the guide rail 11 by a predetermined interval when the guide member 21 is sled to the end of the guide rail 11 so as to close the panorama sun roof 20.

Further, a side portion of the end of the guide rail 11 molded in the leaf spring S may be mounted with a guide hole 12 to implement the vertical extraction and expansion of the guide rail 11 when the guide member 21 is sled to the guide rail 11.

Meanwhile, a lower portion of the end of the guide rail 11 is mounted with an auxiliary guide rail 13 and one side of the auxiliary guide rail 13 is mounted with an auxiliary guide hole 14, such that the guide member 21 can be easily sled along the guide rail 11.

By this configuration, according to the exemplary embodiment of the present invention, the end of the guide rail 11 of the roof panel 10 is molded in the end of the guide rail 11 in the leaf spring S to vertically expand and contract the end of the guide rail 11 when the guide member 21 of the panorama sun roof 20 is sled along the guide rail 11 so as to close the panorama sun roof 20, thereby preventing noise and vibrations from occurring between the guide member 21 and the guide rail 11.

In the sliding structure of the panorama sun roof for a vehicle according to the exemplary embodiment of the present invention configured as described above, the roof panel of a vehicle mounted with the panorama sun roof is mounted with the guide rail and is mounted with the guide member for the panorama sun roof slidably moving along the guide rail of the roof panel and the end of the guide rail is molded in the leaf spring having elasticity to prevent noise and vibrations from occurring at the time of closing the panorama sun roof, thereby improving the value of commodities.

As set forth above, the exemplary embodiments of the present invention can prevent noise and vibrations from occurring at the time of closing the panorama sun roof, thereby improving the value of commodities.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A sliding structure of a panorama sun roof for a vehicle, wherein a roof panel of the vehicle is mounted with the panorama sun roof, the sliding structure comprising:
a guide rail mounted to the panorama sun roof, wherein an end of the guide rail is molded with an elastic member; and
a guide member mounted in the guide rail for the panorama sun roof to slidably move along the guide rail of the roof panel.

2. The sliding structure of the panorama sun roof for the vehicle according to claim 1, wherein the elastic member is a leaf spring.

3. The sliding structure of the panorama sun roof for the vehicle according to claim 2, wherein the leaf spring is shaped of “ [symbol] ”.

4. The sliding structure of the panorama sun roof for the vehicle according to claim 1, wherein a side portion of the end of the guide rail molded in the leaf spring is mounted with a guide hole.

5. The sliding structure of the panorama sun roof for the vehicle according to claim 1, wherein a lower portion of the end of the guide rail is mounted with an auxiliary guide rail and one side of the auxiliary guide rail is mounted with an auxiliary guide hole.

6. The sliding structure of the panorama sun roof for the vehicle according to claim 5, wherein the auxiliary guide hole is positioned between the auxiliary guide rail and the guide rail.
